(19) United States
(12) Patent Application Publication
(10) Pub. No.: US 2025/0225056 A1
(43) Pub. Date: Jul. 10, 2025

(54) SYSTEM AND METHOD FOR HYBRID OBSERVABILITY OF HIGHLY DISTRIBUTED SYSTEMS

(71) Applicant: Amir KRAYDEN, Netanya (IL)

(72) Inventor: Amir KRAYDEN, Netanya (IL)

(21) Appl. No.: 18/854,005

(22) PCT Filed: Apr. 5, 2023
(86) PCT No.: PCT/IL2023/050378

§ 371 Date: Oct. 3, 2024

Related U.S. Application Data
(60) Provisional application No. 63/327,743, filed on Apr. 5, 2022.

(51) Int. Cl. G06F 11/3604

(52) U.S. Cl. CPC G06F 11/3612

(57) ABSTRACT

The invention uses application monitoring software running on individual machines, as well as network monitoring software to observe the operations of multiple machines and the networks connecting them, in order to achieve efficient understanding of highly distributed systems. Applications are monitored at multiple levels including cloud, edge and all levels in between, in order to detect the existence of and classify the type of network and application and infrastructure components, provide an efficient way to monitor these components in real time, provide an efficient way to find correlations between discrete parts (e.g. servers, containers, APIs) of the system, understand different deployment alternatives, and provide a means to provide Root Cause Analysis when a fault or degradation is detected in the service or application performance.

### FIELD OF THE INVENTION

The present invention relates generally to the field of computer and network monitoring and analysis, anomaly detection, trend forecasting, predictive maintenance, and modeling and designing application and network infrastructure.

### BACKGROUND OF THE INVENTION

Software systems design has radically changed over the past decades. Historically software was monolithic and single-purpose, often coming as part of a single software unit, stemming from the service operator owning both infrastructure and software assets. Today's software more often uses advanced component-based or micro-service-based architectures, stemming from the move to Cloud or Hybrid infrastructures. These microservices or components are modular units each designed to perform a small task and communicate with other such microservices such that together they provide a complete solution to a problem. Each microservice may run on its own server or servers, and different services may be written in different languages and have access to different sets of data.

Thus, instead of a set of servers that handle all kinds of synchronization, transactions, and failover scenarios together, the microservice approach uses several individual services that may be physically located at different locations, evolve and are updated independently, and aren't tied to each other. This causes some fundamental challenges unique to distributed computing including fault tolerance, synchronization, self-healing, backpressure, network splits, and much more.

Along with the benefits of using micro-service-based (e.g. Kubernetes) architectures, which include: scalability, agility, flexibility, availability, short innovation cycles and lower total cost of ownership for complex services, come a number of drawbacks that stem from having to handle and observe more complex, distributed systems, both in terms of the application and the underlying infrastructures (devices, networks, content locations, deployments and cloud services).

Design complexity, data consistency and redundancy, interservice overhead, implementation detail, sizing, distributed logs in potentially multiple formats, increased attack surface, unexpected interdependency, stateless nature, and ‘cognitive overload’ on the IT and SRE personnel who must deal with these systems, all contribute to the problems of developing and using microservice-based architecture. To make matters worse, the programming paradigms often taught as good software habits (such as functional decomposition, “Don't Repeat Yourself”, and re-usable functionality) often lead to problems when used with microservices.

When dealing with a microservices environment, there can be various reasons for a runtime failure or degradation, such as the microservice itself, its container, the deployment architecture, or even the network interconnecting the various services. Any failure would result in complex intermediate states, which would be difficult to recover from in most cases.

Even if every service dependent on another service is determined and confirmed before testing, interdependencies between services may cause unexpected errors. Downtime of one service due to service outages, service upgrades, etc., can have cascading downstream effects, causing errors for other microservices. A single transaction may span multiple services, and, as a result, issues in one area can cause problems elsewhere. Thus, beyond independently testing individual services, one needs to consider integration of services and their interdependencies while devising such a system.

Open-source projects like Istio are very useful at collecting metrics that allow developers to create dashboards. This process works well when dealing with a smaller application and there are dedicated teams monitoring and adjusting alerts. When working on a project with large-scale deployment, however, these manual processes are much less effective and otherwise requires large investment of man labor, using teams of SREs (Site Reliability Engineers) that are responsible to observe, respond to and mitigate a complex service.

Without the ability to visually monitor multiple clusters, servicing such technologies need to go beyond “observing” and move towards automated anomaly detection.

The process of understanding the internals of a distributed system and being able to analyze it methodically for debugging purposes or SLA preservation is a hurdle shared by many companies.

In many respects, the ability to combine the advantages of micro-service-based architecture with the simplicity of analyzing and debugging monolithic systems would yield a great engineering advantage.

A number of attempts have been made to ease the transition to microservice architectures. For example US2019129821A1 Systems and Techniques for Adaptive Identification and Prediction of Data Anomalies, and Forecasting Data Trends Across High-Scale Network Infrastructures looks for anomalies in computer systems by use of “time-series data sequence from one or more computing devices . . . indicating a performance metric” and comparing such series over several time periods. However, such a system will be ‘blind’ to any of a number of potentially-disastrous changes that leave the performance metrics unchanged until disaster strikes, as well as potentially being unable to deal with situations where the computing devices become isolated from the rest of the network, such that their metrics become unavailable. Such systems do not ‘see’ the connectivity of the network involved and thus cannot build a representation of the network nor its state of health.

WO2020251839A1 GENERATING DATA STRUCTURES REPRESENTING RELATIONSHIPS AMONG ENTITIES OF A HIGH-SCALE NETWORK INFRASTRUCTURE provides a system that “identifies relationships between entities of an infrastructure of a computing system and that is configured to update in response to changes in the infrastructure of the computing system and thus is adapted to build a network representation by ‘analyzing usage data to determine a correlation between” entities. However, this system does not allow for classification of different types of network or its state of health, nor does conceive of corrective actions that might be taken to rectify network problems.

It would thus solve a long-felt need to introduce a system adapted to rectify the shortcomings.

Moreover, the aforementioned approaches are limited to only network views; a real service is spread across all layers of application and infrastructure, and degradation or malfunctions can be at root caused by any layer-or even situations which are affected by cross-layer effects.

### SUMMARY OF THE INVENTION

The invention uses application monitoring software running on individual machines, and network monitoring software able to observe the operations of multiple machines and the networks connecting them, in order to achieve several goals. These include: providing an efficient way to determine the structure and classify the type of network and various application and infrastructure components; providing a set of efficient ways to monitor these components in real time; providing an efficient way to find correlations between discrete parts of the system to determine nominal distributed logic behavior and detect malfunctioning parts prior to adverse events occurring; to provide RCA (Root Cause Analysis) when a fault or degradation is detected in the service or application performance; and finally, to proactively propose and possibly implement different deployment alternatives for the application level, including the way the infrastructure is utilized.

The foregoing embodiments of the invention have been described and illustrated in conjunction with systems and methods thereof, which are meant to be merely illustrative, and not limiting. Furthermore, just as every particular reference may embody particular methods/systems, yet not require such, ultimately such teaching is meant for all expressions notwithstanding the use of particular embodiments.

### BRIEF DESCRIPTION OF THE DRAWINGS

Embodiments and features of the present invention are described herein in conjunction with the following drawings:

FIG. 1 shows inputs of the invention including agents and probes.

FIG. 2 depicts infrastructure layers as detected by the application.

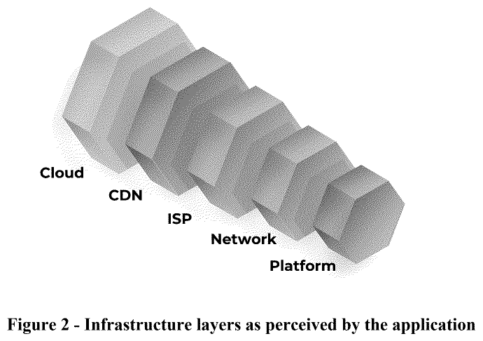

FIG. 3 shows a hybrid observability architecture.

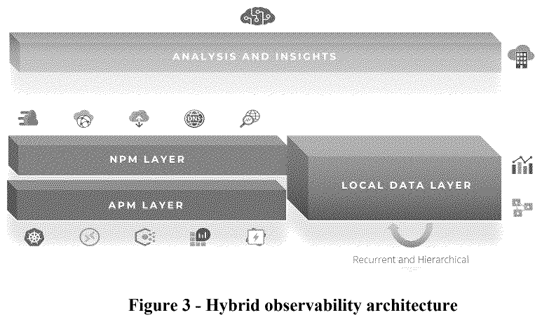

FIG. 4 shows a scheme of the invention for deep graph analysis.

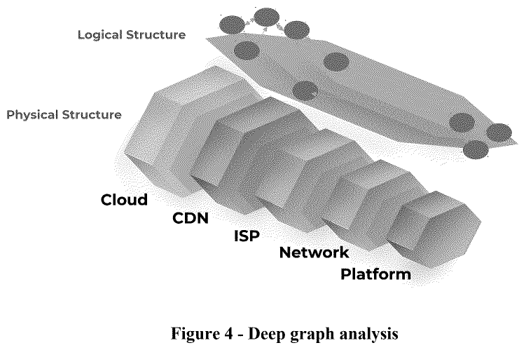

FIG. 5 shows a block diagram for an on-device analytics engine.

FIG. 6 shows a block diagram for an off-device analytics engine of the invention.

### DEFINITIONS

API—Application Programmable Interface
APM—Application Performance Monitoring
AR—Auto Regression
CDN—Content Delivery Network
CPU—Central Processing Unit
GCN—Graph Convolutional Network
GNN—Graph Neural Network
ISP—Internet Service Provider
LSTM—Long Short-Term Memory
ML—Machine Learning
NPM—Network Performance Monitoring
SLA—Service Level Agreement
SLI—Service Level Indicator
SLO—Service Level Objective
TCO—Total Cost of Ownership
TS—Time-series
PCA—Principal Component Analysis
PoV—Point of View
RCA—Root Cause Analysis
SRE—Service Reliability Engineering

### DETAILED DESCRIPTION OF PREFERRED EMBODIMENTS

The present invention will be understood from the following detailed description of preferred embodiments, which are meant to be descriptive yet not limiting. For the sake of brevity, some well-known features, methods, systems, procedures, components, circuits, and so on, are not described in detail.

### Bird's Eye View

The inventive technology is focused on solving the challenges of reliably maintaining a highly distributed system by providing a way to observe distributed software and infrastructure elements, using data-analytics and machine-learning to make sense of different data-points so that a context can be built.

In order to achieve the above, the following parts work in conjunction:
1. Adaptive rate metric sampling from devices (servers), looking at performance counters from:
a. The application layers
b. The network layers
c. The hardware layers
2. On-device and off-device probing engines:
a. Algorithms that enrich the above with knowledge about how the underlying infrastructure is performing, including but not limited to:
i. The organization's network
ii. The Internet Service Provider's (ISP) network
iii. The CDN (Content Delivery Network)
iv. The Cloud(s) infrastructure being utilized in steady or failure states (e.g. providers, regions, availability zones)
3. On-device analytics engine:
a. A sub-set of the metrics (application, network, hardware) collected at the device (controlled by a configuration policy) is analyzed at first locally on the device, including:
i. Time-series auto baselining—learning and predicting the metric so that a probability distribution is defined for the metric and its behavior is streamlined
ii. Anomaly detection—Following the baselining, relevant metrics are sought for detecting anomalies (deviations in the metric's expected absolute value or any of its derivatives)
b. The above is done to save network and compute resources and to speed-up the analysis process
4. Off-device/System-level analysis:
a Since every “on-device” method analyzes behavior from that sub-system's PoV (Point of View), in order to gain a systematic view and correlate behaviors between different nodes, system level analytics suites are used to provide the following:
i. Building a deep graph representing the system's components and underlying infrastructure and analyzing the graph (by means of classical graph theory and Graph Neural Networks [GNN]) in real time to classify:
The physical and logical structure of the system;
The logical purpose of each sub-component (by analyzing both connectivity patterns and performance metrics);
The graph topology, link, nodes, nodes features;
ii. Prediction of on-device metrics to complement and keep the system-level and device-level baselining and anomaly detection algorithms in sync;
iii. Deep analysis of anomalous metrics behavior:
Our method must consider the effect of intervening in the systems operation from a performance PoV, both locally and globally;
Therefore, analysis of metrics using complex deep-learning algorithms which are resource intensive by nature is done off-device-this allows for better accuracy (trend tracking) and understanding of the metric behavior and to enhance the accuracy of the on-device algorithms-this part requires and efficient software and hardware accelerations;
iv. Deep explanations and correlations engines:
With the above achieved, the analytics systems can account for two major elements in analyzing the interactions (cause and effect) and mathematical relations between system parts (co-trend tracking).
Explainability:
1. A metric of relevance (under anomalous behavior) at the time of relevance (the time window on which it is misbehaving) is analyzed by setting it as a class in a machine learning system
2. The algorithms find the set of weights for other metrics (and usually at preceding times) collected which best explain what influenced the behavior
Correlation:
3. A set of metrics are analyzed together as a group to find a mathematical connection between their values and any of their derivatives (co-trend tracking)

In the following we explain the above overview in more detail.

One aim of the invention is to achieve efficient understanding of highly distributed systems (from the geo-location and software architecture points of view). To accomplish this, the invention uses application monitoring software running on individual machines, as well as network monitoring software able to observe the operations of multiple machines and the networks connecting them. Applications are monitored at multiple levels including cloud, edge, and all levels in between, in order to:
1. Provide an efficient way to detect the existence of and classify the type of network and various application and infrastructure components.
2. Provide an efficient way to monitor these components in real time.
3. Provide an efficient way to find correlations between discrete parts (e.g. servers, containers, APIs) of the system to:
a. find the nominal distributed logic behavior, and;
b. detect malfunctioning parts prior to adverse events occurring.
4. Provide a means to provide RCA (Root Cause Analysis) when a fault or degradation is detected in the service or application performance.
5. Understand and proactively suggest different deployment alternatives at the application level, and the way the infrastructure is utilized. This involves taking into account the relevant SLIs (Service Level Indicators) for each system component, and whether or not SLOs (Service Level Objectives) will be met using a given alternative—so that the system's overall SLA (Service Level Agreement) can be maintained. This may be done by assessing compliance with the SLA for each alternative, and choosing between alternative deployments based upon the SLIs, SLOs and possibly other indicators. Deployment alternatives may include different network connectivity, different numbers, locations, and deployment implementation of servers, and different containers and/or software running on the aforementioned servers.

Some other requirements for the inventive solution follow. Since many applications are large enough that they are impossible to monitor manually, the solution must independently track and learn from data in real-time. There should ideally be a low false-positive rate for ‘problem alerts’ where the system detects anomalies or other trouble (as these will lead to unnecessary noise and create ‘alert fatigue’ amongst the IT/SRE crew)—but the false-negative rate must be even lower, since not reporting a real problem may have potentially disastrous results. Failures should be contained, and managed from a safe context outside the failed component.

### Inputs, Outputs, Temporal and Historic States

In order to understand the scope of invention we will describe the inputs to and outputs from the system, as well as what type of data is stored for various algorithms to operate upon.

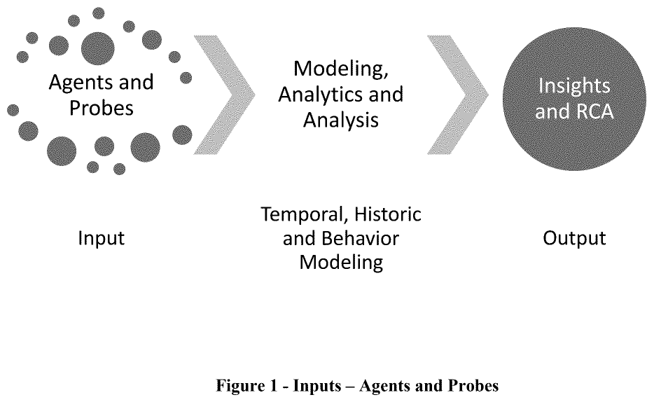

In one embodiment, the overall flow of the data (shown also in FIG. 1) comprises a combination of:
1. APM (Application Performance Monitoring) software that gathers node metrics (e.g., CPU usage, Memory usage, Hard drive usage, etc.), application metrics (e.g., container, processes, threads and their relevant properties);
2. NPM (Network Performance Monitoring) software that gathers metrics including connectivity maps, delays, delay variations, traffic level and type, and identity of directly and indirectly connected neighbors (which represents used APIs, network equipment and such).
3. Pre-processing and local data-layer software which prepares and does lower level machine learning processing on the data (as will be described later).
4. Aggregation, display and GUI software which allows for presenting the data collected by the previous three software elements, in several different views showing different data or different presentations of common data. The different views are made to be particularly useful to different roles in an organization, such as SREs (site-reliability engineers), dev-ops team, security team. algorithms team, etc.

These software elements may all be implemented as or make use of agents and/or probes running on various nodes used by an application.

The analysis provided by the invention is carried out in distributed fashion on many elements (containers, servers, cloud locations, etc.) each of which host parts of the entire service observed. Analysis of these elements is carried out in part by ‘agents’ which comprise code running on the elements themselves. The invention furthermore uses probes which are special types of agents, not installed in customer premises but instead in special-purpose offsite locations (cloud locations and partners locations [e.g., ISPs, CDNs]). The purpose of these probes is to enrich the customer data by providing a global view into the availability and performance of these locations.

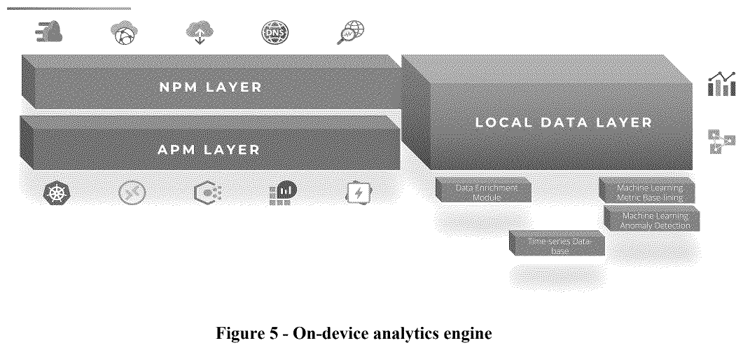

An example an instance of an agent appears in FIG. 5.

### Main Computational Processing—Modelling, Analytics and Analysis

The input layer data coming from the agents and probes essentially comprises:
1. A set of pre-processed TSs (Time-series) that represent relevant metrics.
2. A topology map (or partial graph) representing the analysis of the agent/probe of its PoV (e.g. what is the agent connected to, how is it connected, what is the connectivity performance).
3. Meta-data representing locally observed phenomena's or anomalies.

With the aforementioned data at-hand coming from multiple nodes, the main computational processing may now perform the following:

### 1. Network Topology Modelling

a. The topology map from each agent/probe representing its PoV (partial-graph) is combined to create a hyper-converged graph.
b. In this process, identical nodes described in different topology maps are converged to the same graph points
c. Each and every Time-series is placed in a data-model to represent its relevant place in the topology (e.g. physical metric, application metric, networking metric).

### 2. Analytics

a. Pre-Learning treatment of outliers in the time-series or graph elements (edges and vertices) to clean the data for prediction or analysis stages.
b. Prediction: a more accurate form of learning the mathematical behavior of a time series and predicting its value or anomalies.
c. Clustering and Dimensionality reduction: A way to mark areas in the graph which have logical, physical or behavioral relationships. This stage is also important to ease the analysis phase and subsequent dimensionality reduction algorithms. The analysis of this stage may be accomplished using unsupervised means, such as K-Means, DBSCAN and other methods as will be known by those skilled in the art for clustering, and PCA, LDA, clustering and other methods as will be known by those skilled in the art for purposes of dimensionality reduction.

### 3. Analysis

a. Graph analysis and prediction may make use of various GGNs (Graph Neural Networks) in a convolutional (GCN), temporal (T-GCN) or relational setting, for purposes of:
i. Classification of graph type
ii. Classification of nodes
iii. Predicting links between nodes
iv. Handling time-varying temporal graphs, including analysis thereof for purposes of classification and anomaly detection.
v. Discovering node features (coming from the entirety of the observed data, from all the agents/probes)
vi. Matching node behavior and topology to known patterns (service-tagging)
b Dimensionality reduction:
i. Use of feature extraction algorithms and dimensionality reduction algorithms as mentioned above (e.g. PCA) to reduce the input to a smaller set of features
c. RCA (root cause analysis) and behavioral discovery:
i. Correlating anomalous metrics to its graph location, along with other observed data that can explain the anomalous behavior
ii. This is similar to predicting a metric but in this case, we are interested in finding the weights of the features that are most important for the behavior explanation. This may be accomplished for instance by means of SHAP, Mean Decrease in Impurity, inspection of linear regression model coefficients, or other methods as will be clear to one skilled in the art.

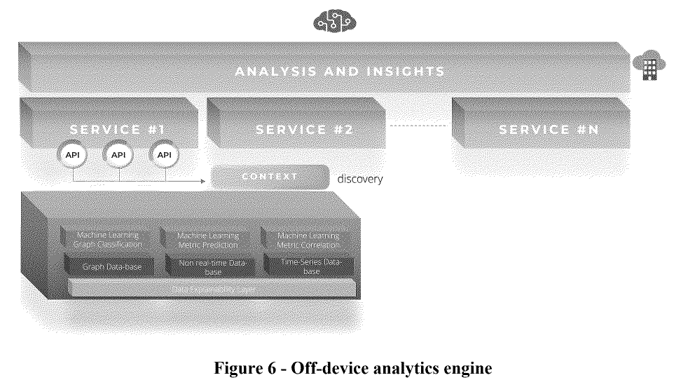

An example for the computational system appears in FIG. 6.

### Insights and Root Cause Analysis (RCA)

The invention also allows for creation of automatic insights and RCA logs to explain observations in terms of their root causes, including as many elements as possible along a chain of causes leading to a given condition.

RCA may be accomplished by means as mentioned before (SHAP, MSI or the like) and/or by means of inspection of logs, e.g. by back-tracking an anomalous behavior to its sources (which may be server changes, software upgrades, server status changes, and the like).

“Insights” provided by the inventive systems and methods refer to automatic explanation concerning the dynamics of the system, phenomena and alternatives (what could be done differently to enhance the system performance and service levels).

These alternatives may be generated by several means. First, replacing error-prone nodes with alternative nodes in the same or different data centers, while reproducing all of its local connectivity, may already serve to mitigate problems that are restricted to individual nodes. This principle may also be applied to larger sections of networks; if a set of nodes are determined to be faulty in some way (e.g., not responding, producing errors, or generating other anomalous data) the entire set may be replaced as before, by reproducing all of the connectivity of the problem nodes with a new set of nodes.

Second, the number, type, location and connectivity of various microservice infrastructure (including for instance containers used to deploy microservices on servers) may be varied in an attempt to mitigate problems. For instance, if it is observed that latency and request backlog for a given microservice is increasing, the number of servers and/or containers deployed to serve this microservice may be increased incrementally. It is within provision of the invention to learn the microservice behavior as a function of these variables (number, type, location, connectivity, and any other variable observed or presumed to have an effect on the latency and/or backlog). Every time the number of containers for a given microservice is changed (for instance) this may be added to a log of similar data, from which the latency, backlog, etc. may be estimated as functions of the variables involved. In this way the system will be able to estimate how many containers to deploy or servers to add (for instance) in a given condition of backlog. Likewise, it is within provision of the invention that the system learn by how much to increase or decrease connectivity, change server locations, change network structure, and deploy different types of microservices by inspection of the previous behavior of the system.

Third, if it is determined that a change in software may be responsible for problems, it is within provision of the invention to roll back software versions to (for example) the last known working version of a given piece of software. This rollback may be micro-service specific, with each microservice having its own versioning and history of problem-free or problematic functioning. Furthermore, correlations between software versions may also be observed and corrected, such that (for instance) if version x for microservice X in conjunction with version y of microservice Y is observed to cause a problem, one or the other or both may be rolled back even if it is not clear which is responsible for the problem (if indeed only one is responsible).

Fourth, neural networks and other machine learning paradigms may be used to generate alternatives. For example, generative adversarial networks (GANs) may be used to generate alternate network structures after having been trained on data of networks that have been used successfully before, where the object being generated may be a specific network, number of servers of given type, locations of servers, software being run, or any other parameter of the network. As further examples, grid search, gradient descent, simplex and other function optimization methods may be used to generate alternative networks given some objective function based on the network to optimize; this objective function may itself be generated by neural network or other means such as regression or interpolation. The objective function may based for instance on performance of networks already seen using (for instance) interpolation, regession, neural net of the like. The objective function may be related to latency, backlogs, bandwidth, degree of adherence to SLA, SLO, and SLI objectives, or other parameters of the network performance.

### GUI

A GUI is a natural way to convey complex data provided by the agents, probes, and analysis algorithms of the invention. Thus as mentioned above aggregation, display and GUI software is provided which allows presentation of the data collected by the previous three software elements, in several different views showing different data or different presentations of common data.

The different views are made to be particularly useful to different roles in an organization such as the SRE/OPS team and the Dev and DevOps teams. The different kinds of views these two groups will see by default are summarized below:

The SRE/OPS team will by default see a UI which very system or SLA oriented. For instance in the case of a certain degradation, a diagram of the service topology may be shown, along with a message to the effect that a degradation in the service has been detected, as well as an indication of the root cause.

This is of great help since treating a problem may be out of a particular engineer's scope-in the case of infrastructure problems (public or private), this is something the SRE can either treat or have DevOps team help with. In the case of an application issue, in the usual case the SRE needs to quickly collect the relevant evidence and send it to the engineering team for solution. But when using the inventive system we can save sending the data (which is created from the data collected by the inventive system and the analysis it does) and simply point the Dev team to a screen of the invention.

The Dev teams/DevOps will by default see the previously mentioned screen that summarizes the issue analysis. Since the system collects a large amount of metrics, they can analyze the metric explanation, message, log and so on at any desired depth and level of detail.

The foregoing description and illustrations of the embodiments of the invention has been presented for the purposes of illustration. It is not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

1. A system for distributed application monitoring and maintenance consisting of:
a. a set of on-device probes adapted to measure on-device performance metrics from application layer, network layers, and hardware layers, and on-device analytics for said on-device performance metrics;
b. a set of off-device probes adapted to measure off-device performance metrics concerning how the underlying infrastructure is performing, including global network performance, ISP performance, CDN performance, and cloud infrastructure (including providers, regions, availability zones), and analytics for said off-device performance metrics;
wherein hybrid on-device and off-device monitoring and maintenance are performed simultaneously for purposes of application monitoring.

2. The system of claim 1 wherein said on-device analytics include time-series baselining and anomaly detection of said on-device performance metrics.

3. The system of claim 1 wherein said off-device analytics include building representations of said application's physical and logical infrastructure, determining the logical purpose(s) of network subcomponents by means of analyzing connectivity patterns and performance metrics, and graph topology link and node features, using said off-device performance metrics.

4. The system of claim 3 wherein said off-device analytics further include prediction of said on-device and said off-device metrics for purposes of baselining and anomaly detection, including deep-learning based analysis of said on-device and said off-device metrics.

5. The system of claim 4 wherein said deep-learning based analysis includes root-cause analysis and correlation analysis.

6. The system of claim 5 wherein said deep-learning based analysis comprises algorithms to find explanations for metric behaviors based on other measured metrics in the distributed system, and correlations comprising mathematical relationships between different distributed metrics and their respective derivatives.

7. The system of claim 3 wherein said representations are built using deep graph analysis to automate classification of physical and logical structure of the application and its underlying infrastructure.

8. The system of claim 1 wherein said on-device analytics are optimized to minimize compute and traversal cost from network and compute perspectives.

9. The system of claim 1 further provided with algorithms adapted to propose and modify said application's network structure, such that the performance of said network may be improved in terms of latency, backlog, or other performance metrics of said application.

10. A distributed monitoring system adapted to analyze and aid the debugging of highly distributed application having an SLA, consisting of on-device probes adapted to measure on-device performance metrics from application layer, network layers, and hardware layers, and off-device probes adapted to measure off-device performance metrics concerning how the underlying infrastructure is performing, including global network performance, ISP performance, CDN performance, and cloud infrastructure (including providers, regions, availability zones).

11. The system of claim 8 adapted to isolate said metrics interfering with said SLA, and further adapted to use said metrics to derive relevant alternative network structures to preserve said SLA.

12. The system of claim 1 further providing auto service tagging using a speculative approach signing performance counter (metrics) and behavior.

13. The system of claim 9 further including automatic creation of service insights.

14. The system of claim 9 further including automatic creation of an RCA log including explanations.

15. A method for distributed application monitoring and maintenance consisting of:
a. Implementing a set of on-device probes adapted to measure on-device performance metrics from application layer, network layers, and hardware layers, and on-device analytics for said on-device performance metrics;
b. Implementing a set of off-device probes adapted to measure off-device performance metrics concerning how the underlying infrastructure is performing, including global network performance, ISP performance, CDN performance, and cloud infrastructure (including providers, regions, availability zones), and analytics for said off-device performance metrics;
c. Gathering data from said on-device probes and said off-device probes for purposes of synthesis and analysis thereof;
wherein hybrid on-device and off-device monitoring and maintenance are performed simultaneously for purposes of application monitoring.

16. The method of claim 15 wherein said on-device analytics include time-series baselining and anomaly detection of said on-device performance metrics.

17. The method of claim 15 wherein said off-device analytics include building representations of said application's physical and logical infrastructure, determining the logical purpose(s) of network subcomponents by means of analyzing connectivity patterns and performance metrics, and graph topology link and node features, using said off-device performance metrics.

18. The method of claim 17 wherein said off-device analytics further include prediction of said on-device and said off-device metrics for purposes of baselining and anomaly detection, including deep-learning based analysis of said on-device and said off-device metrics.

19. The method of claim 18 wherein said deep-learning based analysis includes root-cause analysis and correlation analysis.

20. The method of claim 19 wherein said deep-learning based analysis comprises algorithms to find explanations for metric behaviors based on other measured metrics in the distributed system, and correlations comprising mathematical relationships between different distributed metrics and their respective derivatives.

21. The method of claim 17 wherein said representations are built using deep graph analysis to automate classification of physical and logical structure of the application and its underlying infrastructure.

22. The method of claim 15 wherein said on-device analytics are optimized to minimize compute and traversal cost from network and compute perspectives.

23. The method of claim 15 further provided with algorithms adapted to propose and modify said application's network structure, such that the performance of said network may be improved in terms of latency, backlog, or other performance metrics of said application.

24. A method for distributed system monitoring adapted to analyze and aid the debugging of highly distributed application having an SLA, consisting of monitoring on-device performance metrics from application layer, network layers, and hardware layers, using on-device probes, and measuring off-device performance metrics concerning how the underlying infrastructure is performing, including global network performance, ISP performance, CDN performance, and cloud infrastructure (including providers, regions, availability zones) using off-device probes.

25. The method of claim 24 adapted to isolate said metrics interfering with said SLA, and further adapted to use said metrics to derive relevant alternative network structures to preserve said SLA.

26. The method of claim 24 further providing auto service tagging using a speculative approach signing performance counter (metrics) and behavior

27. The method of claim 24 further including automatic creation of service insights.

28. The method of claim 24 further including automatic creation of an RCA log including explanations.
